(19) United States
(12) Patent Application Publication
(10) Pub. No.: US 2012/0142118 A1
(43) Pub. Date: Jun. 7, 2012

(54) MICROFABRICATION OF HIGH TEMPERATURE MICROREACTORS

(75) Inventors: J. Thomas Brenna, Ithaca, NY (US); Herbert J. Tobias, Ithaca, NY (US)

(73) Assignee: Cornell University, Ithaca, NY (US)

(21) Appl. No.: 13/322,410

(22) PCT Filed: May 27, 2010
(86) PCT No.: PCT/US10/36358

§ 371 Date: Jan. 12, 2012

Related U.S. Application Data
(60) Provisional application No. 61/250,278, filed on Oct. 9, 2009.
(60) Provisional application No. 61/181,944, filed on May 28, 2009.

(51) Int. Cl. G01N 27/72; B32B 38/10; G01N 30/02

(52) U.S. Cl. 436/161; 436/173; 422/603; 216/33

(57) ABSTRACT

Microreactors, methods of fabricating, and using such microreactors comprises a substrate having an outer periphery and composing two monolithic sections, each of said monolithic sections comprising two opposed main surfaces and one or more edges extending between the main opposed surfaces. One of the main surfaces from each of the monolithic sections are joined together at a substantially planar junction. The microreactor further comprises at least one microcapillary flow passage defined by surfaces within said substrate and having first and second ends. One or more inlets connect the outer periphery of said substrate with the first end of said microcapillary flow passage. One or more outlets connect the outer periphery of said substrate with the second end of said microcapillary flow passage, which may narrowingly taper. The substrate can be made from high purity fused silica. A metallic reagent and/or catalyst can be incorporated in the micro capillary passage.

This application claims the benefit of U.S. Provisional Patent Application Ser. No. 61/181,944, filed May 28, 2009, and U.S. Provisional Patent Application Ser. No. 61/250,278, filed Oct. 9, 2009, which are hereby incorporated by reference in their entirety.

This invention was made with government support under United States Anti-Doping Agency (USADA) Grant No. 3998356. The government has certain rights in this invention.

### FIELD OF THE INVENTION

The present invention relates to microfabrication of high temperature microreactors.

### BACKGROUND OF THE INVENTION

Some analytical methodologies employ reactors to chemically or thermally convert individual organic molecules “on-line” to enable the measurement. A prime example is gas chromatography (GC) coupled to high-precision isotope ratio mass spectrometry (IRMS) for the measurement of the stable isotopic composition (e.g. isotope ratios of ¹³C/¹²C, ²H/¹H, ¹⁵N/¹⁴N, ¹⁸O/¹⁶O, or others) of individual compounds in a mixture separated upstream by GC (Asche, S. et al, “Sourcing Organic Compounds Based on Natural Isotopic Variations Measured by High Precision Isotope Ratio Mass Spectrometry,” Current Organic Chemistry, 7: 1527-1543 (2003); Sessions, A. L., “Isotope-Ratio detection for Gas Chromatography,” J Sep Sci, 29: 1946-61 (2006)). The compounds of interest must be chemically converted to an inert gas, e.g., CO₂ for ¹³C/¹²C and N₂ for ¹⁵N/¹⁴N, before the isotope ratio can be measured in the IRMS. In other schemes, decomposition products of an individual compound by pyrolysis at high temperatures are of interest, and these products are either measured by molecular mass spectrometry and/or chemically converted in a second reactor in order to measure their isotopic composition (Corso, T. N. et al., “High-Precision Position-Specific Isotope Analysis,” Proc. Nat. Acad. Sci. USA, 94: 1049-1053 (1997)).

High precision gas isotope ratio mass spectrometry (IRMS) is the established technique for the measurement of the natural isotopic variability of the organic elements, C, N, O, S, and H, which enables the determination of the geographic, chemical, and biological origins of substances, and is employed in a wide range of disciplines. Some examples include detection of athletic steroid doping, the sourcing and authentication of foods, natural products, and drugs, non-radioactive tracer analysis for biomedical research, and a plethora of forensics applications. In carbon isotope ratio analysis of ¹³C/¹²C, for example, the analyte must be converted to CO₂ for analysis; therefore, most analytes must be chemically transformed by combustion (Asche et al., “Sourcing Organic Compounds Based On Natural Isotopic Variations Measured by High Precision Isotope Ratio Mass Spectrometry,” Current Organic Chemistry 7:1527-43 (2003); Brenna et al., “High-Precision Continuous-Flow Isotope Ratio Mass Spectrometry,” Mass Spectrometry Reviews 16:227-58 (1997); and Sessions A., “Isotope-Ratio Detection for Gas Chromatography,” Journal of Separation Science 29:1946-61 (2006)). Compound-specific isotope analysis was enabled by the integration of gas chromatography (GC) with IRMS via an online combustion interface (GCC-IRMS) (Matthews et al., “Isotope-Ratio-Monitoring Gas Chromatography-Mass Spectrometry,” Anal. Chem. 50:1465-73 (1978)). In other schemes, decomposition products of an individual compound by pyrolysis at high temperatures are of interest, and the products are either measured by molecular mass spectrometry and/or chemically converted in a second reactor in order to measure their isotopic composition by IRMS (Corso et al., “High-Precision Position-Specific Isotope Analysis,” Proc. Nat. Acad. Sci. USA 94:1049-53 (1997); Brenna et al., “High-Precision Continuous-Flow Isotope Ratio Mass Spectrometry,” Mass Spectrometry Reviews 16:227-58 (1997)).

The reactors employed in these systems are normally embodied as an alumina (ceramic) tube (U.S. Pat. No. 5,432,344 to Brand et al.; U.S. Pat. No. 5,012,052 to Hayes J.; and Matthews et al., “Isotope-Ratio-Monitoring Gas Chromatography-Mass Spectrometry,” Anal. Chem. 50:1465-73 (1978)) loaded with a reactant of interest, or no reactant and/or a catalyst in the case of pyrolysis (Burgoyne et al., “Quantitative Production of H₂ by Pyrolysis of Gas Chromatographic Effluents,” Anal. Chem. 70:5136-41 (1998); Corso et al., “High-Precision Position-Specific Isotope Analysis,” Proc. Nat. Acad. Sci. USA 94:1049-53 (1997); and Tobias et al., “On-Line Pyrolysis as a Limitless Reduction Source for High-Precision Isotopic Analysis of Organic-Derived Hydrogen,” Anal. Chem. 69:3148-52 (1997)). In order to improve peak shapes for chromatography by reducing dead volumes associated with connections, a continuous fused silica capillary design was reported and refined (Corso et al., “High-Precision Position-Specific Isotope Analysis,” Proc. Nat. Acad. Sci. USA 94:1049-53 (1997); U.S. Pat. No. 5,783,741 to Ellis et al.; Goodman K., “Hardware Modifications to a VG Isochrom Yielding Improved Signal, Resolution, and Maintenance,” 210th ACS National Meeting. Chicago Ill.: American Chemical Society (1995); Goodman K., “Hardware Modifications to an Isotope Ratio Mass Spectrometer Continuous-Flow Interface Yielding Improved Signal, Resolution, and Maintenance,” Anal Chem 70:833-7 (1998); Sacks et al., “Fast Gas Chromatography Combustion Isotope Ratio Mass Spectrometry,” Analytical Chemistry 79:6348-58 (2007); and Tobias et al., “Comprehensive Two-Dimensional Gas Chromatography Combustion Isotope Ratio Mass Spectrometry,” Analytical Chemistry 80:8613-21 (2008)) and is in use in several laboratories. Apart from the input and output ends, the reactor is held in a high-temperature furnace. For example, in ¹³C/¹²C analysis, CuO, heated between 850-960° C., is used as a source of O₂ in order to combust organic molecules to CO₂ gas. The dimensions of the reactors range from inner diameters (i.d.) of 500 μm for the alumina tubes, down to the state of the art of 250 μm i.d. for fused silica capillary. The lengths of the reaction hot zone in currently employed systems range from 150 to 200 mm.

Recently, the coupling of these systems to more advanced upstream GC separation techniques have been demonstrated, using a 250 μm i.d. GC fused silica capillary reactor, to enable more rapid separation by fast-GCC-IRMS (Sacks et al., “Fast Gas Chromatography Combustion Isotope Ratio Mass Spectrometry,” Analytical Chemistry 79:6348-58 (2007)) and improved separations of complex sample mixtures by comprehensive 2D GC (GC×GCC-IRMS) (Tobias et al., “Comprehensive Two-Dimensional Gas Chromatography Combustion Isotope Ratio Mass Spectrometry,” Analytical Chemistry 80:8613-21 (2008)). These techniques require the preservation of very narrow peak shapes produced in the gas-phase separations; therefore, post-column band broadening can be further minimized by reducing the i.d. of the reactor from the current value of 250 μm. In addition, improvement of the physical stability of the reactor is required at temperatures up to 1000° C. and beyond. These issues were addressed here, for the first time, by microfabrication to create a microreactor. The present invention describes an approach towards a microfabricated microreactor (MFMR) and its capabilities.

The present invention is aimed to overcome known deficiencies in the art. For example, the present invention provides the capability of creating very narrow bore (i.d.) passages, e.g. <100 μm, coupled with the capability to deposit the desired reactant or reactant precursor metal in said passages. The narrow inner diameter (i.d.) is required for preserving narrow gas plugs and their peak shapes associated with advanced upstream compound separation techniques such as fast GC and GC×GC. The low end of the i.d. of the tube and capillary reactors is currently limited by the ability to physically fill the reactor with reactant.

It also provides for the potential to create very long passages in a relatively small area by use of serpentine type patterns, for example, 1 m length or more in less than 3 cm² area. This reduces reactor size while allowing an increase in reaction zone lengths. This is not possible with the tube or capillary reactor designs.

The present invention also provides a means to fabricate a reactor in relatively thick fused silica substrates. Both alumina tubes and glass capillary are very fragile, especially at high temperatures. A micro-fabricated microreactor is very robust with much greater thicknesses and physical stability. This aspect of the present invention makes field operation of the methodology possible.

The present invention is directed to overcoming the deficiencies in the art.

### SUMMARY OF THE INVENTION

In a first aspect, the present invention relates to a microreactor comprising a substrate having an outer periphery and comprising two monolithic sections. Each of the monolithic sections comprises two opposed main surfaces and one or more edges extending between the main opposed surfaces. One of the main surfaces from each of the monolithic sections are joined together at a substantially planar junction. The microreactor further comprises at least one microcapillary flow passage defined by surfaces within the substrate and having first and second ends. One or more inlets connect the outer periphery of the substrate with the first end of said microcapillary flow passage. One or more outlets connect the outer periphery of the substrate with the second end of said microcapillary flow passage. The inlet and/or outlet narrowingly tapers from the outer periphery of the substrate into the microcapillary flow passage.

In a second aspect, the present invention relates to a microreactor comprising a substrate having an outer periphery and comprising two monolithic, high purity fused silica sections. Each of the monolithic sections comprises two opposed main surfaces and one or more edges extending between the main opposed surfaces. One of the main surfaces from each of the monolithic sections are joined together at a substantially planar junction. The microreactor further comprises at least one microcapillary flow passage defined by surfaces within the substrate and having first and second ends. One or more inlets connect the outer periphery of the substrate with the first end of said microcapillary flow passage. One or more outlets connect the outer periphery of the substrate with the second end of said microcapillary flow passage.

In a third aspect, the present invention relates to a microreactor comprising a substrate having an outer periphery and comprising two monolithic sections. Each of said monolithic sections comprises two opposed main surfaces and one or more edges extending between the main opposed surfaces. One of the main surfaces from each of the monolithic sections are joined together at a substantially planar junction. The microreactor further comprises at least one microcapillary flow passage defined by surfaces within the substrate and having first and second ends. A metallic reagent and/or catalyst is coated on the surfaces of the substrate defining the at least one microcapillary flow passage. One or more inlets connect the outer periphery of the substrate with the first end of said microcapillary flow passage. One or more outlets connect the outer periphery of the substrate with the second end of said microcapillary flow passage.

In a fourth aspect, the present invention relates to a method of fabricating a microreactor. This method comprises providing a substrate having an outer periphery and comprising a pair of monolithic sections. Each of the monolithic sections comprises two opposed main surfaces and one or more edge extending between the opposed main surfaces. A microcapillary flow passage is etched in one of the main surfaces of each of the pair of monolithic sections, where the microcapillary flow passage is defined by surfaces in the substrate and has first and second ends. One or more inlet is etched in the etched main surface of each of the pair of monolithic sections which extends through the edge and is connected to the first end of the microcapillary flow passage. One or more outlet is etched in the etched main surface of each of the pair of monolithic sections which extends through the edge and is connected to the second end of the microcapillary flow passage. Each of the etched main surfaces of the monolithic sections are joined together with the one or more inlet, the microcapillary flow passage, and the one or more outlet in alignment. The one or more inlet and/or the one or more outlet narrowingly tapers from the outer periphery of said substrate to the microcapillary flow passage.

A fifth aspect of the present invention relates to a method of fabricating a microreactor. This method comprises providing a high purity fused silica substrate having an outer periphery and comprising a pair of monolithic sections. Each of the monolithic sections comprises two opposed main surfaces and one or more edge extending between the opposed main surfaces. A microcapillary flow passage is etched in one of the main surfaces of each of the pair of monolithic sections, where the microcapillary flow passage is defined by surfaces in the substrate and has first and second ends. One or more inlet is etched in the etched main surface of each of the pair of monolithic sections which extends through the edge and is connected to the first end of the microcapillary flow passage. One or more outlet is etched in the etched main surface of each of the pair of monolithic sections which extends through the edge and is connected to the second end of the microcapillary flow passage. Each of the etched main surfaces of the monolithic sections are joined together with the one or more inlet, the microcapillary flow passage, and the one or more outlet in alignment.

A sixth aspect of the present invention relates to a method of fabricating a microreactor. This comprises providing a substrate having an outer periphery and comprising a pair of monolithic sections. Each of the monolithic sections comprises two opposed main surfaces and one or more edge extending between the opposed main surfaces. A microcapillary flow passage is etched in one of the main surfaces of each of the pair of monolithic sections, where the microcapillary flow passage is defined by surfaces in the substrate and has first and second ends. One or more inlet is etched in the etched main surface of each of the pair of monolithic sections which extends through the edge and is connected to the first end of the microcapillary flow passage. One or more outlet is etched in the etched main surface of each of the pair of monolithic sections which extends through the edge and is connected to the second end of the microcapillary flow passage. A metallic reagent and/or catalyst is coated on the surfaces of the substrate defining the microcapillary flow passage. Each of the etched, coated main surfaces of the monolithic sections are joined together with the one or more inlet, the microcapillary flow passage, and the one or more outlet in alignment.

The present invention relates to the use of microfabrication to create a microreactor. The microreactor is significantly more robust than existing related technologies. Robust, high temperature microreactors for on-line conversion of organic compounds can be microfabricated in, for example, high purity fused silica to enable stable isotopic compositional analysis of individual compounds in mixtures using advanced gas chromatography (GC) separation techniques, such as fast GC and comprehensive 2D GC, coupled to isotope ratio mass spectrometry (IRMS). These microreactors could also be manufactured at larger passage dimensions to enable robust operations for normal GCC-IRMS applications. Photolithography can be used to define the reactor passage pattern on high purity fused silica, with a protective layer of amorphous silicon. A two-step isotropic wet etching process, using 49% HF, selectively created semi-circular cross-section micro-passages of arbitrary diameters (56-505 μm), with tapered sections leading to input/output ports (>400 μm) that accept fused silica capillary tubing used in GC and MS peripherals. Non-limiting aspects to the fabrication process include a “two-step wet etch” to create tapered connection ports for input and output capillaries, and an in situ chemical vapor deposition process. Pairs of symmetric mirror image substrates can then be aligned and bonded to form enclosed circular passages. The resulting microreactors are more robust than the standard designs made of fragile fused silica capillary or alumina tubes of relatively large bore, and are gas tight at temperatures up to 1000° C. Fast GC plugs of CH₄ with and without the reactor revealed that peak shapes are minimally affected by the microreactor when carrier flow rate and passage diameter are optimized. Peak shapes with full widths at half maximum of 250 ms are shown for plugs of CH₄ through a fast-GC-combustion-IRMS system interfaced with a microreactor containing a CuO/NiO combustion source, enabling carbon isotope ratio measurements of CH₄ with a precision of SD(δ¹³C)=±0.28‰. The devices enable arbitrarily narrow bores and long path passages that can be operated as open tubes or loaded with a reactant, in a small, robust package.

The process steps to create circular passages have been modified and adapted to the use of this microreactor and resembles those of recent microfabrication of passages in silicon substrates (U.S. Pat. No. 5,575,929 to Yu et al., which is hereby incorporated by reference in its entirety), glass substrates (impure SiO₂ such as pyrex) (Iliescu et al., “On the Wet Etching of Pyrex Glass,” Sensors and Actuators a-Physical, 143:154-161, (2008); Iliescu, C., et al., “Strategies in Deep Wet Etching of Pyrex Glass,” Sensors and Actuators a-Physical, 133: 395-400 (2007); Iliescu, C., et al., “Characterization of Masking Layers for Deep Wet Etching of Glass in an Improved HF/HCl Solution,” Surface & Coatings Technology, 198: 314-318 (2005); Bu, M. Q., et al., “A New Masking Technology for Deep Glass Etching and its Microfluidic Application,” Sensors and Actuators a-Physical, 115: 476-482, (2004), which are hereby incorporated by reference in their entirety), and pure fused silica (Grosse, A., et al., “Deep Wet Etching of Fused Silica Glass for Hollow Capillary Optical Leaky Waveguides in Microfluidic Devices,” Journal of Micromechanics and Microengineering, 11: 257-262 (2001), which is hereby incorporated by reference in its entirety). The process of the present invention can be performed in high purity fused silica (SiO₂), a harder material to micro-machine which is required for high temperature applications. Pure fused silica has a much higher melting point but etches many times slower than impure SiO₂, requiring well chosen protective layer masks for long etch times.

### BRIEF DESCRIPTION OF THE DRAWINGS

FIG. 1 shows an expanded view of an example of the microreactor in accordance with the present invention.

FIG. 2 shows an example CAD image of a photomask with a channel pattern for two micro-reactors. In particular, these figures show the micro-reactor channel pattern (200), the input and output channel ends of the reactor pattern (202), and a wafer flat alignment bar (204). In the 2 step wet etch process, after complete immersion for a short time, the wafer can be stood up in the etchant for a further extended period, for example, to the level of arrow (202) to create tapers to wider port channels.

FIGS. 3A-R show an example of how to make the microreactor. FIGS. 3A-Q depict the cross-sections of the substrate, coatings, and etching. FIG. 3R shows an overhead view of the device. Color legend for the cross-sections, blue=fused silica, green=amorphous Si, violet=photoresist, pink=exposed photoresist, gray=Cr, orange=Cu, and white=removed material. The arrows represent light.

FIGS. 4A-C show the microreactor device of the present invention. FIG. 4A is a schematic view of the final version of a microreactor (MFMR), before the connection of GC tubing (fused silica capillary) to the source input (GC) and reactor output (FID or IRMS) ports. The hot zone passage region is held at high temperature for combustion. The number, length, bend radius, and the layout design of the passage loops can be varied as required. FIG. 4B shows a photo of a completed MFMR comprised of a 195 μm diameter passage (D_{c}) and 75 μm diameter Constantan (55% Cu/45% Ni) wire (D_{w}) in the hot zone region of 230 mm in length (L) and 3 mm loop radius (R), resulting in an effective diameter of <185 μm (L230R3D_{c}195D_{w}75). FIG. 4C shows the same MFMR in a test-bed furnace during operation. MFMR's were created containing hot zone passages with diameters varying from 56 to 505 μm, hot zone lengths, ranging from 150-840 mm, and passage bend radii of 0.35-4.1 mm.

FIGS. 5A-F show examples of layout designs for passages. In the case of FIGS. 5A-F, these are serpentine passages. Example CAD (Layout Editor™) images of (A-F) photomasks with passage patterns for two microreactors each with various (i) hot zone passage lengths and bend radii, including the input and output passage ends (ii), and a wafer flat alignment bar (iii) used in the 2 step wet etch process. Masks are mirror-symmetric to allow enclosure of passages. For convenient reference, photomask patterns are code marked with LwwRxx, where ww stands for the Length (L) of the passage in the hot zone in millimeters (mm), and xx stands for the passage Bend Radius (R) in mm.

FIGS. 6A-C shows an overview of an exemplary method for microfabrication of the microreactor of the present invention. Depictions of the cross-sections of the substrate, coatings, and etching are shown. Substrate preparation is shown in FIG. 6A, structure fabrication is shown in FIG. 6B, and device packaging process work-flows are shown in FIG. 6C.

FIGS. 7A-B show an evaluation of analyte peak broadening. CH₄ gas was used to evaluate the analyte peak broadening through MFMRs (pattern L275R0_{—}65 with no reactant) with various passage diameters at various furnace temperatures and GC head pressures using helium carrier gas in a fast GC-FID (Gas chromatography-flame ionization detection) system. All MFMR hot zone passage lengths were 275 mm and passage diameters studied included 55, 77, 85, 155, and 185 μm. In all cases, 2 μl of CH₄ was injected at a 50:1 split, resulting in 1.7 nmol analyzed. An HP6890 GC-FID at various head pressures was used in FIG. 4A and FIG. 4B, ranging from <1 ml/min to 6 ml/min, depending on head pressure and MFMR passage dimensions. The optimized passages of 155 & 185 μm, at head pressures >45 psi had flow rates of ˜3-6 ml/min.

FIGS. 8A-B show peak shapes of analytes. FIG. 8A shows 2 μl injections at 50:1 split, 1.7 nmol of CH₄ through 1.7 m×100 μm i.d. (inner diameter) fused silica capillary without MFMR and with MFMR (L275R0_{—}65D_{c}185 with no reactant) at 950° C. using an HP6890 GC-FID with head pressure of 55 psi, and FID detection. FIG. 8B shows peak shapes of 5 μl injections, at 100:1 split, 2 nmol of CO₂ and CH₄ through 2.5 m×100 μm i.d. capillary, plus 0.5 m×75 μm i.d. IRMS inlet capillary, without MFMR and with MFMR (L230R3D_{c}195D_{w}75 with oxidized metal reactant), with effective passage diameter <185 μm, using an HP6890 GC with head pressure of 50 psi, and IRMS detection of m/z 44 (MAT 252 IRMS). Data points are 40 ms apart (acquisition rate=25 Hz). These are the peak shapes for the data presented in FIG. 9 and Table 1 shown infra, and are achieved at a flow rate of ˜3 ml/min.

FIG. 9 shows ¹³C/¹²C (δ¹³C) measured for 10 consecutive injections of CO₂ and CH₄. The gases CO₂ and CH₄ were used to evaluate the extent of combustion and reproducibility of ¹³C/¹²C isotope ratios produced by the MFMR. Injection volumes were 5 μl through the instrumental set up described in FIG. 8B. At a 100:1 split, this represents the analysis of approximately 2 nmol of each gas. ¹³C/¹²C's were calculated relative to the ¹³C/¹²C of the first injection for each gas and is the same data summarized in Table 1 shown infra.

FIGS. 10A-B schematically show GC-C-CRDS. As shown in 10A, the sample is separated with a gas chromatograph, combusted to produce CO₂ and measured using cavity ring-down spectroscopy. Mass flow controllers are used to add oxygen before the catalytic combuster and nitrogen before the CRDS instrument. FIG. 10B shows the cavity ring-down line shape profiles of the R(36) line of ¹²C¹⁶O¹⁶O and the R(12) line of ¹³C¹⁶O¹⁶O for the (3,0⁰,1)-(0,0⁰,0) combination band of carbon dioxide near 6251 cm⁻¹. The traces are of carbon dioxide in the atmosphere at 45° C. and total pressure of 140 torr.

FIG. 11 shows a representative ¹²CO₂ post-combustion chromatogram of a 60 μl methane injection. The peak width at baseline is 1 min, allowing for enough data points across for peak integration purposes

### DETAILED DESCRIPTION OF THE INVENTION

In a first aspect, the present invention relates to a microreactor comprising a substrate having an outer periphery and comprising two monolithic sections. Each of the monolithic sections comprises two opposed main surfaces and one or more edges extending between the main opposed surfaces. One of the main surfaces from each of the monolithic sections are joined together at a substantially planar junction. The microreactor further comprises at least one microcapillary flow passage defined by surfaces within the substrate and having first and second ends. One or more inlets connect the outer periphery of the substrate with the first end of said microcapillary flow passage. One or more outlets connect the outer periphery of the substrate with the second end of said microcapillary flow passage. The inlet and/or outlet narrowingly tapers from the outer periphery of the substrate into the microcapillary flow passage.

In a second aspect, the present invention relates to a microreactor comprising a substrate having an outer periphery and comprising two monolithic, high purity fused silica sections. Each of the monolithic sections comprises two opposed main surfaces and one or more edges extending between the main opposed surfaces. One of the main surfaces from each of the monolithic sections are joined together at a substantially planar junction. The microreactor further comprises at least one microcapillary flow passage defined by surfaces within the substrate and having first and second ends. One or more inlets connect the outer periphery of the substrate with the first end of said microcapillary flow passage. One or more outlets connect the outer periphery of the substrate with the second end of said microcapillary flow passage.

In a third aspect, the present invention relates to a microreactor comprising a substrate having an outer periphery and comprising two monolithic sections. Each of said monolithic sections comprises two opposed main surfaces and one or more edges extending between the main opposed surfaces. One of the main surfaces from each of the monolithic sections are joined together at a substantially planar junction. The microreactor further comprises at least one microcapillary flow passage defined by surfaces within the substrate and having first and second ends. A metallic reagent and/or catalyst is coated on the surfaces of the substrate defining the at least one microcapillary flow passage. One or more inlets connect the outer periphery of the substrate with the first end of said microcapillary flow passage. One or more outlets connect the outer periphery of the substrate with the second end of said microcapillary flow passage.

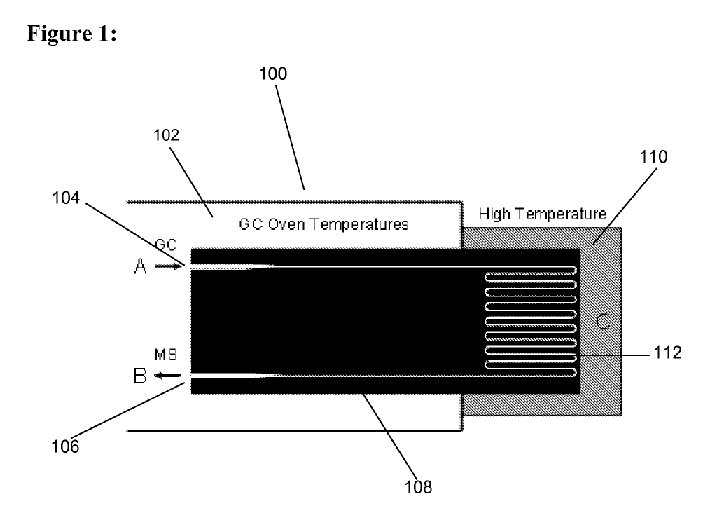

FIG. 1 is a schematic drawing showing a microreactor heating system 100 in accordance with the present invention. This system includes microreactor 108 extending into low temperature furnace 102 with the reactor's hot zone passages 112 further passing into high temperature furnace 110. Material to be heated A (which may be exiting a GC device) passes into microreactor 108 through inlet 104 and exits through outlet 106 as heated material B (which may be subsequently passed to an MS device).

The microreactor of the present invention can comprise a capillary tube coupled to the one or more inlet and a capillary tube coupled to the one or more outlet. In this manner, the inlet and/or outlet of the microcapillary flow passage can be coupled to gas chromatography and mass spectroscopy peripherals.

In one embodiment the microcapillary flow passage comprises either two or more parallel flow passages, two or more flow passages which merge together into one flow passage, or a flow passage that splits into two or more flow passages. The length of the microcapillary flow passage can be varied as required for the particular application. Lengths of 15 to 30 cm are generally useful. In one embodiment, the microcapillary flow passage has a diameter in the range of 50 to 500 μm.

In another embodiment, the microcapillary flow passage has either a serpentine pattern, concentric pattern, or any desired pattern designed for a specific purpose. The present invention is not limited to any specific passage shape. The passage can take on any shape suitable for easy connection to any system. For instance, a straight passage with input at one end and output at the opposite end can be used in many applications.

The microcapillary flow passage can be substantially coplanar with the planar junction. Further, the one or more inlet and said one or more outlet extend through the edge of the joined monolithic sections of said substrate and are substantially coplanar with the planar junction.

A metallic reagent and/or catalyst may be placed within the microcapillary flow passage. In one embodiment of this aspect of the present invention, the metallic reagent and/or catalyst can be coated on the surfaces of the substrate defining said microcapillary flow passage. Suitable metals include copper, nickel, and platinum. Alternatively, if the bend radii of the passage loops are of appropriate radius, metal can be inserted in the form of wire.

The substrate for microreactor of the present invention can be made of high purity fused silica. Alternatively, it can also be made from materials such as silica, crystalline quartz, silicon carbide, and ceramics. It is desirable for the substrate to withstand temperatures up to 1500° C.

In a fourth aspect, the present invention relates to a method of fabricating a microreactor. This method comprises providing a substrate having an outer periphery and comprising a pair of monolithic sections. Each of the monolithic sections comprises two opposed main surfaces and one or more edge extending between the opposed main surfaces. A microcapillary flow passage is etched in one of the main surfaces of each of the pair of monolithic sections, where the microcapillary flow passage is defined by surfaces in the substrate and has first and second ends. One or more inlet is etched in the etched main surface of each of the pair of monolithic sections which extends through the edge and is connected to the first end of the microcapillary flow passage. One or more outlet is etched in the etched main surface of each of the pair of monolithic sections which extends through the edge and is connected to the second end of the microcapillary flow passage. Each of the etched main surfaces of the monolithic sections are joined together with the one or more inlet, the microcapillary flow passage, and the one or more outlet in alignment. The one or more inlet and/or the one or more outlet narrowingly tapers from the outer periphery of said substrate to the microcapillary flow passage.

In one embodiment of this aspect, the method is carried out by etching the microcapillary flow passage by immersing the main surface of each of the pair of monolithic sections in an etching solution. The one or more inlet, and one or more outlet is etched by immersing only the one or more edge of the substrate through which the one or more inlet and the one or more outlet extends in the etching solution so that the inlet and outlet are exposed to further etching.

A fifth aspect of the present invention relates to a method of fabricating a microreactor. This method comprises providing a high purity fused silica substrate having an outer periphery and comprising a pair of monolithic sections. Each of the monolithic sections comprises two opposed main surfaces and one or more edge extending between the opposed main surfaces. A microcapillary flow passage is etched in one of the main surfaces of each of the pair of monolithic sections, where the microcapillary flow passage is defined by surfaces in the substrate and has first and second ends. One or more inlet is etched in the etched main surface of each of the pair of monolithic sections which extends through the edge and is connected to the first end of the microcapillary flow passage. One or more outlet is etched in the etched main surface of each of the pair of monolithic sections which extends through the edge and is connected to the second end of the microcapillary flow passage. Each of the etched main surfaces of the monolithic sections are joined together with the one or more inlet, the microcapillary flow passage, and the one or more outlet in alignment.

A sixth aspect of the present invention relates to a method of fabricating a microreactor. This comprises providing a substrate having an outer periphery and comprising a pair of monolithic sections. Each of the monolithic sections comprises two opposed main surfaces and one or more edge extending between the opposed main surfaces. A microcapillary flow passage is etched in one of the main surfaces of each of the pair of monolithic sections, where the microcapillary flow passage is defined by surfaces in the substrate and has first and second ends. One or more inlet is etched in the etched main surface of each of the pair of monolithic sections which extends through the edge and is connected to the first end of the microcapillary flow passage. One or more outlet is etched in the etched main surface of each of the pair of monolithic sections which extends through the edge and is connected to the second end of the microcapillary flow passage. A metallic reagent and/or catalyst is coated on the surfaces of the substrate defining the microcapillary flow passage. Each of the etched, coated main surfaces of the monolithic sections are joined together with the one or more inlet, the microcapillary flow passage, and the one or more outlet in alignment.

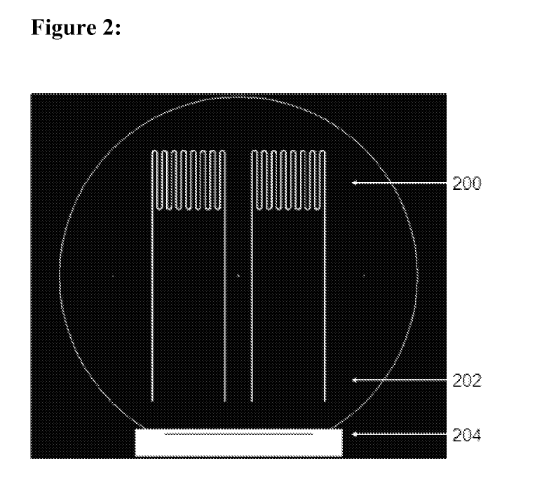

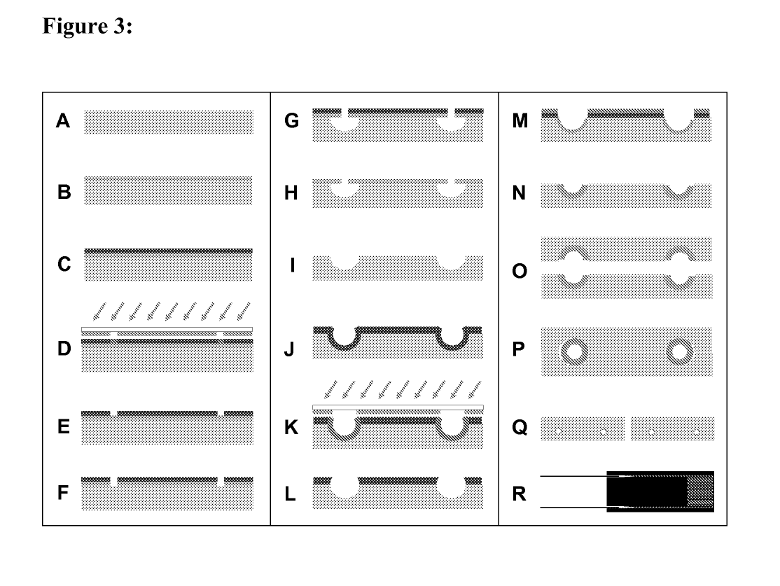

The method of fabricating the microreactor of the present invention can involve steps as shown in FIGS. 2 and 3.

### Photomask

Using standard techniques, a photomask is generated with the microreactor passage pattern (FIG. 2 at 200), where white regions are transparent. The pattern is made symmetric so that mirror image pairs can be matched later in the process. In addition, the input and output passage ends of the reactor pattern (FIG. 2 at 202), which will become the ports, both lead to the edge of the substrate perpendicular to a wafer flat alignment bar (FIG. 2 at 204). The width of the passages in the pattern are made significantly narrower, e.g. 10 μm, than the ultimately etched passage width, e.g. 90 μm.

### Protective Layer Mask.

A substrate, preferably high purity fused silica, e.g., 100 mm diameter and 1 mm thick, is useful for photolithography (FIG. 3A). After thorough cleaning (e.g., in basic and acidic solutions), one working side is coated with a protective layer mask (FIG. 3B), which is a coating that is resistant to the etchant that will be used. This is a thin layer of material, (e.g., 250 nm), which is produced with a low amount of defects, such as by chemical vapor deposition of amorphous silicon.

In addition to amorphous silicon, alternative protective layer masks can be used to define passage patterns during wet etching. Examples include use of single layers or multiple layers of “hard mask” metals, such as Cr/Au, and/or various etch resistant “soft mask” photoresists (Iliescu, et al., “On the Wet Etching of Pyrex Glass,” Sensors and Actuators a-Physical 143: 154-161 (2008); Iliescu et al., “Strategies in Deep Wet Etching of Pyrex Glass,” Sensors and Actuators a-Physical 133: 395-400 (2007); Iliescu et al., “Characterization of Masking Layers for Deep Wet Etching of Glass in an Improved HF/HCl Solution,” Surface & Coatings Technology 198: 314-318 (2005); Bu, M. Q., et al., “A New Masking Technology for Deep Glass Etching and its Microfluidic Application,” Sensors and Actuators a-Physical 115: 476-482 (2004); Grosse, A., et al., “Deep Wet Etching of Fused Silica Glass for Hollow Capillary Optical Leaky Waveguides in Microfluidic Devices,” Journal of Micromechanics and Microengineering 11: 257-262, (2001), which are incorporated by reference in their entirety).

### Passage Definition

A photoresist (e.g., broadband positive resist) is then coated on top of the hard mask (FIG. 3C). The wafer is aligned under the photomask according to its wafer flat and an alignment bar (FIG. 3C) before being exposed by light through the photomask. The photomask is then exposed to light (FIG. 3D). The affected photoresist is then removed using a developer, (e.g., 300 MIF), defining the channel pattern (FIG. 3E).

### Passage Exposure

The exposed regions in the hard mask are then plasma etched, (e.g., using a CF₄ plasma), thereby finally exposing the fused silica surface (FIG. 3F). The substrate is then baked for many hours, (e.g., 90° C. for 24 hrs), to help the remaining photoresist act as an additional barrier to the etchant.

### Two Step Wet Etch

A two step isotropic wet etching process is used to create the varying diameter half semi-circular cross sectional micro-passages. Each pair of wafers that ultimately are to be bonded, are etched together to retain as much uniformity as possible. First, the pair of wafers are fully immersed in the etchant, (e.g., HF or HF containing such as HF/HCl, NH₄F/HF, etc.) for a few minutes, dependent on the desired “hot zone” passage dimensions (FIG. 3G). Second, the pair of wafers is stood up facing each other on their wafer flat in the etchant (FIG. 3C), for an additional extended period of time, so that only a few mm of the passage “ends” are immersed (FIG. 3B) and etched wider than the rest of the pattern. This creates a widening taper from the hot zone passages to the input and output port passages. The photoresist is then stripped off using solvents (FIG. 3H), and the remaining hard mask is removed by plasma etching or appropriate wet etching (FIG. 3I), (e.g., CH₄ plasma or KOH wet etch for amorphous silicon).

### Metal Reactant Deposition

If the reactor is to be used for chemical conversion, metallization of the passages is performed. One of two general methods can be used, one before enclosing the passages or one after enclosing the passages. In the method involving metallization before enclosure, the metallization maybe isolated to the passages in the hot zone region using a photoresist. A photoresist, such as a spray on positive resist, can be applied to the substrate surface (FIG. 3J), followed by exposure to light using a photomask with passage pattern widths just smaller that the width of the etched half semi-circle passages (FIG. 3K). The exposed photoresist is then removed with a developer, (e.g., 300 MIF) (FIG. 3L). First, a thin-film adhesion and conducting layer, (e.g., Ti, Au, Cr, etc.) is deposited by an appropriate technique such as sputtering, evaporation, or chemical vapor deposition (CVD, FIG. 3M). CVD can then be used to deposit a metal/metal precursor as a thin film (nm's). Alternatively, the photoresist is removed with solvents, leaving only the adhesion/conducting metal deposited in the passages, followed by electroplating or electroless plating to deposit the metal/metal precursor, (e.g., Cu), in thick films (FIG. 3N).

In the method involving metallization after enclosure, the vapors of a volatile liquid metal complex, (such as those used in CVD) can be directed through the passages while the port regions are near ambient temperature and the hot zone region at elevated temperature. In this manner, the metal is deposited via thermally induced disproportionation in the hot zone.

Coating the passages using a solution (i.e. CuSO₄ in water) can be also used with subsequent drying and heating to create the metal or metal precursor of interest, (i.e. Cu) for ultimate CuO combustion reactant. Alternatively, if the bend radii of the passage loops are of appropriate radius, metal can be inserted in the form of wire.

### Passage Enclosure

Before enclosing the passages, two mirror image substrates are thoroughly cleaned using acidic and basic solutions. The two substrates are then aligned, (e.g., under a microscope or using alignment pins) (FIG. 3O), and pressed together (FIG. 3P). Any observable fringe lines must not be crossing any passage region for a successful bond. The pair is then annealed at high temperature (e.g., 1100° C., for a few hours). This facilitates a gas tight bond over a large range of temperatures (e.g., approximately 20-1000° C.).

### Device Packaging

The reactor(s) are then diced out of the bonded pair (FIG. 3Q), where capillary source input and reactor output port openings are created by cutting across the widened passage ends. These ports act to accept and center the source input and reactor output fused silica capillary normally used in GC/MS methodology (FIG. 3R). Each capillary is secured gas tight in each port using a heat resistant sealant.

### Conversion of Precursor Reactant

In some cases, the metal deposited in the hot zone passages is not the final form of the reactant. As a result, the deposit needs to be converted in situ. For example, in the case of a combustion reactor, deposited Cu is converted to CuO by passing O₂ gas through the reactor at 600° C. over a period of time.

Alternative etching processes can be used to make the passages. For example, deep reactive ion etching (DRIE) with SF₆ and Xe gases can be used to make passages with rectangular cross sections (Li, et al., “Smooth Surface Glass Etching by Deep Reactive Ion Etching With SF6 and Xe Gases,” Journal of Vacuum Science & Technology B, 21:2545-2549 (2003), which is hereby incorporated by reference in its entirety). However, DRIE suffers from being extremely slow in fused silica, making it expensive.

Non-Photolithographic Passage Fabrication can also be used for the purposes of the present invention. Femtosecond laser pulses can be used to define regions in the fused silica substrate, that subsequently can be wet etched, (e.g., in HF) up to 100 times faster than unaffected regions (Bellouard, Y., et al., “Fabrication of High-Aspect Ratio, Micro-Fluidic Passages and Tunnels Using Femtosecond Laser Pulses and Chemical Etching,” Optics Express 12:2120-2129 (2004), which is hereby incorporated by reference in its entirety). Width and depth of affected regions can be controlled. An advantage of this technique is no protective layer mask is required, but, since it is non-standard in the field, its reliability and expense is unknown.

Microfabrication processes described in the present invention can also be used to create microreactors in materials other than fused silica, such as silicon for comparable but perhaps lower maximum temperature applications compared to fused silica, or SiC for higher temperature applications than fused silica, (e.g., pyrolysis production of H₂ at 1450° C. for ²H/¹H).

Other methods for forming the micro-fluidic passages are possible, including processes such as grayscale photolithography and “nanoglassblowing” ((Stavis, S., et al., “Nanofluidic Structures with Complex Three-dimensional Surfaces,” Nanotechnology 20: 165302 (2009); Strychalski, E., et al., “Non-planar Nanofluidic Devices for Single Molecule Analysis Fabricated Using Nanoglassblowing,” Nanotechnology 19:315301 (2008), which are hereby incorporated by reference in their entirety). These methods are capable of forming tapered passages and represent alternative embodiments of the invention.

There are many applications of the present invention. Some non-limiting applications of the present invention are described below.

In one embodiment, the present invention is used to carry out a method of heating a material. This method comprises providing a microreactor according to the present invention and heating said microreactor. A material is passed through the inlet, the microcapillary flow passage, and the outlet of the heated microreactor to heat the material. The heated material is recovered after it is discharged from the outlet of the heated microreactor. This method may cause the material to undergo a chemical or biological reaction.

The method of the present invention further comprises subjecting the recovered heated material to chemical analysis. The chemical analysis can be carried out with an instrument selected from the group consisting of a gas chromatograph, a mass spectrometer, an isotope ratio monitoring gas chromatograph mass spectrometer (irm-GC/MS), a molecular mass spectrometer, and spectrometer or spectroscopy instrument for chemical or isotopic analysis.

The microreactors of the present invention could be used as a peripheral in instruments used to measure the stable isotopic composition of organic molecules. This permits the determination of the geographic, chemical, and biological origins of substances in a wide range of disciplines. Some examples of uses include the sourcing and authentication of foods, natural products, and drugs, non-radioactive tracer analysis for biomedical research, and a plethora of forensics applications. The present invention can be used for the advancement of methodology for the detection of synthetic steroids and other synthetic compounds in sports anti-doping tests.

The microreactors of the present invention can be used as an interface between a Gas Chromatograph (GC) and a molecular mass spectrometer for pyrolysis or reactions subsequent to separation and prior to mass spectrometer analysis. For example, the interface could be between an electrospray ion source and a molecular mass spectrometer. This will permit pyrolysis-based dissociation of covalent or non-covalent complexes or reaction-based molecular modification prior to introduction to a molecular mass spectrometer.

The interface could also be between any inlet and an elemental mass spectrometer, such as an inductively coupled plasma mass spectrometer. This arrangement can be used for pyrolysis-based dissociation of covalent or non-covalent complexes, or reaction-based molecular modification prior to introduction.

The microreactor could also be an interface between any inlet and any elemental analysis device, (such as an inductively coupled atomic emission spectrometer). This system is useful for pyrolysis-based dissociation of covalent or non-covalent complexes, or reaction-based molecular modification prior to introduction. The microreactor could also be the interface between two separation devices, such as two GCs. This configuration permits pyrolysis-based dissociation of covalent or non-covalent complexes, or reaction-based molecular modification prior to introduction.

The microreactor of the present invention could be the interface between an atmospheric pressure inlet to a mass spectrometer and any transfer device for conveying analyte into a mass spectrometer. Examples of atmospheric pressure inlet devices are DART (Direct Analysis in Real Time) or DESI (desorption electrospray ionization). The interface could also be any interface that uses a plasma for modification of analytes prior to transfer to another component (such as a mass spectrometer) for chemical analysis.

The present invention can be used as a reactor coupling a gas chromatograph (GC) with a mass spectrometer (MS), where the compounds from the GC need to be chemically converted or thermally broken down (i.e. subjected to pyrolysis) for MS analysis. The hot zone passage region (containing the reactant or the site of pyrolysis) can be placed in a furnace at high temperature, depending on the required process. The inlet/outlet end region sits outside the furnace, but inside the GC oven, which usually ramps anywhere between ambient temperature and 400° C. during the separation process. The source input capillary is connected to the output of the GC separation column, while the reactor output capillary is connected to the transfer capillary leading to the MS via any other devices in between that are required for the methodology.

The microreactor of the present invention can be used for on-line combustion for GC-IRMS of ¹³C/¹²C or O¹⁸/O¹⁶ measurements. This reactor is coated with metals such as Cu, Ni, and/or Pt, followed by in situ oxidation of the metals (excluding Pt) with O₂ gas to form CuO and/or NiO. Two reactors could be coupled in-line for on-line combustion/reduction for GC-IRMS of N¹⁵/N¹⁴ measurements. The first reactor is used as described supra, while the second reactor could have similar metals, but those metals need not be oxidized. The microreactor could be used for on-line pyrolysis of organic material with subsequent GC separation and molecular MS identification of decomposition products. The reactor would not have any deposited metals.

The microreactor of the present invention could also be used in a system with multiple reactors for on-line pyrolysis of organic material, followed by subsequent GC separation and on-line combustion and/or reduction for isotopic analysis of decomposition products. The microreactor could also be used with any of these techniques that use fast GC or GC×GC (comprehensive two dimensional Gas Chromatography) separations upstream of on-line reaction(s). These microreactors would enable the high performance coupling to these GC techniques.

### EXAMPLES

### Example 1

### Photomask Generation

The CAD software utility Layout Editor™ (freeware) was used to create a drawing and an exported graphic data system (GDSII) file of the microreactor passage design. The file was used to guide the exposure of photoresist on a chromium coated, 5 inch (124 mm) square glass substrate using a GCA Mann 3600 Pattern Generator (D. W. Mann/GCA Corporation, USA). The photoresist was developed using 300 MIF developer (Hoechst Celanese, Somerville N.J.) for 120 sec, water rinsed and spin dried. The exposed chrome layer was removed using CR-14 Chromium Etchant (Cyantek Corporation, Fremont Calif.) for 120 sec, water rinsed, and spin dried. Photoresist was subsequently removed by hot stripping in a 75° C. bath containing propylene glycol, n-methyl-pyrrolidone (NMP), and tetramethyl ammonium hydroxide (TMAH) for 20 min, water rinsed, and spin dried.

### Example 2

### Furnace Processing

Double side polished 100 mm diameter, 1.0 mm thick, synthetic amorphous high purity fused silica wafers (Corning 7980, Mark Optics, Santa Ana Calif.) were thoroughly cleaned, as used for metal oxide semiconductor technology, before furnace processing by sequential immersion in a base (6 L H₂O, 1 L NH₄OH, 1 L H₂O₂), acid (6 L H₂O, 1 L HCl, 1 L H₂O₂), and HF (20:1 H₂O:HF) bath for 10 min, 10 min, and 15 sec, respectively. The wafers were water rinsed to 16 MΩ after each bath then spun dry. Low pressure chemical vapor deposition (LPCVD) was used to deposit a layer of approximately 250 nm of amorphous Si using a furnace processing tube (Cryco, Austin Tex.). Three different Si deposition recipes (SR) were tested. SR1 included a 150 sccm flow of silane (SiH₄) at 140 mTorr and 560° C. for 100 min. SR2 included a 150 sccm flow of SiH₄ at 140 mTorr and 540° C. for 250 min. And SR3 included a 150 sccm flow of SiH₄ and a 10 sccm flow of 1.5% PH₃/N₂ (PH₃:SiH₄ ratio of 1×10⁻³) at 150 mTorr and 540° C. for 250 min.

### Example 3

### Wafer Photolithography

The LPCVD Si surface of each high purity fused silica wafer was dehydrated at 115° C. for 1 min on a hot-plate and then cooled. Wafers were then treated and manually spin coated with a solution containing 20% hexamethyldisilazane and 80% propylene glycol monomethyl-ether acetate (MicroPrime P-20 Primer, Shin-Etsi Chemical Company, Japan) as an adhesion promoter, and then spin coated with a 1.3 μm layer of broadband photoresist (Shipley Microdeposit S1813, Rohm & Haas, Philadelphia Pa.) at a rotational speed of 4000 rpm for 60 sec. Each wafer was then immediately soft-baked at 115° C. for 1 min on a hot-plate and then cooled. The photoresist on the wafers was exposed using 405 nm light (20 mW/cm²) for 3.0 sec by means of “soft” contact with the photomask using a HTG System III-HR Contact Aligner (Hybrid Technology Group Inc., Scotts Valley Calif.) The photoresist was developed using 300 MIF developer for 120 sec, water rinsed and spin dried. The exposed amorphous Si surface was plasma etched at 150 W for 11 min using a 30 sccm flow of CF₄ at 40 mTorr (Oxford PlasmaLab 80, Oxford Instruments, Oxfordshire UK).

### Example 4

### Isotropic Wet Etching

The wafers, with the exposed passages and remaining amorphous Si and photoresist, were baked for ˜24 hours at 90° C. before performing a “two step isotropic wet etch”. A solution of 49% HF in water (Mallinckrodt Baker Inc., Phillipsburg N.J.) was used as the high purity fused silica wet etchant for creation of passages. The etch rate was measured to be ˜1 μm/min at 25° C. Both wafers of a pair that were to be ultimately bonded were etched in the same bath. A pair of wafers were first fully immersed in the etchant for 10-70 min (dependent on desired hot zone passage dimensions), then immersed in water for 5 min, and subsequently dried with air. The pair of wafers was then stood on end with each half facing one another on their wafer flat in the etchant, for an additional amount of time to total ˜190 min, so that only a few (5-8) mm of the passage “ends” were immersed and etched more than the rest. The wafers were then immersed in water for 10 min, rinsed, and dried with air. Remaining photoresist was removed by the hot stripping method mentioned above, followed by plasma ashing with reactive oxygen using a Gas Sonics Aura 1000 (Novellus Systems Inc., San Jose Calif.). The native oxide layer was removed by placing the wafers in a 30:1 buffered oxide etch bath (BOE) for 60 sec, then the amorphous Si layer was removed by placing the wafers in a 20% KOH bath.

### Example 5

### Passage Enclosure and Device Packaging

Surface roughness of the processed wafers before cleaning and bonding was measured to be <8 angstroms (root mean square) by atomic force microscopy (DI Dimension 3100 AFM, Veeco Instruments, Plainview N.Y.). Extensive cleaning procedures were performed to ensure successful bonding. First, the wafers were cleaned according to the acid/base procedure described above, with the replacement of the HF solution immersion with a second base solution immersion. Then, a 10 min Piranha clean was performed using 1:1 96% H₂SO4 and 30% H₂O₂. Alignment of the features on the two mirrored wafers was performed by hand under an ABM contact aligner microscope (ABM Inc., Scotts Valley Calif.) and gently compressed in the center by hand to form an initial bond. The wafers were then annealed at 1100° C. for 5 hours in a furnace processing tube (Cryco, Austin Tex.). The microreactors were cut out of the bonded wafers using a K&S 7100 Dicing Saw (Advanced Dicing Technologies, Horsham Pa.). Capillary port openings were created by cutting across the widened passage ends. Appropriate metal reactant in the form of wire was inserted into the hot zone passage loop region. A few mm of one end of fused silica capillary tubing (0.5 m×100 μm i.d. and 360 μm o.d.) was coated with Pyro-Putty 950 (Aremco, Valley Cottage N.Y.), inserted into each of the port regions, and further sealed and secured with TorrSeal (Varian Inc., Palo Alto Calif.). In one case, the exclusive use of polyimide resin was also tested to coat and seal fused silica capillary into the ports.

### Example 6

### Fast Gas Chromatography-Flame Ionization Detection (GC-FID) and Fast Gas Chromatography Combustion-Isotope Ratio Mass Spectrometry (GCC-IRMS)

An HP6890A GC-FID (Agilent Technologies, Menlo Park, Calif.) were used for gas plug injections and flame ionization detection (FID). A MAT 252 IRMS (Thermo Finnigan, Bremen, Germany) was used to measure carbon isotope ratios, ¹³C/¹²C. The MAT 252 IRMS was run with the variable ion source conductance window open (by three turns). The RC time constants of all three faraday cup detectors were modified to be 30 ms (Tobias et al., “Comprehensive Two-Dimensional Gas Chromatography Combustion Isotope Ratio Mass Spectrometry,” Analytical Chemistry 80:8613-21 (2008), which is hereby incorporated by reference in its entirety), in order to facilitate accurate data acquisition for the narrow peak shapes observed in this work. The MFMR was placed partially inside an open tubular glass fiber furnace (Thermcraft Inc., Winston-Salem N.C.). In the case of fast GC-FID experiments, a total length of 1.7 m deactivated fused silica capillary with a 100 μm i.d. was used to couple the MFMR with the GC split/splitless inlet and the FID detector. In the case of fast GCC-IRMS experiments, the same 1.7 m length capillary was used to couple the MFMR with the GC inlet and an additional 0.8 m deactivated fused silica capillary with a 100 μm i.d. was used as a transfer capillary between the MFMR and the IRMS open split. A portion of the effluent was sampled into the IRMS by placement of the upstream end of 1 m×75 μm i.d. IRMS sampling fused silica capillary nominally flush with the end of the transfer capillary within a Press-Tight® (Siltek Restek, Bellefonte, Pa.) connector, thereby operated as an open split. Immersion of 6 cm of the transfer capillary into a dry ice/acetone water trap (at −78° C.) was used to remove water vapor, generated from the combustion process, before reaching the IRMS.

### Example 7

### IRMS Data Acquisition and ¹³C/¹²C Analysis

A home-built LabView (National Instruments, Austin, Tex.) based IRMS data acquisition and reduction system, “SAXICAB”, was used to monitor the m/z 44, 45, and 46 signals, for ⁴⁴CO₂, ⁴⁵CO₂, ⁴⁶CO₂, from the MAT 252 IRMS head amplifiers. The faraday cup detector RC time constants were modified for fast GC peak detection. Details can be found elsewhere (Tobias et al., “Comprehensive Two-Dimensional Gas Chromatography Combustion Isotope Ratio Mass Spectrometry,” Analytical Chemistry 80:8613-21 (2008), which is hereby incorporated by reference in its entirety). All data sets were processed for ¹³C/¹²C analysis through SAXICAB. The ¹³C/¹²C is normally reported in 6 notation with respect to an international standard, in units of per mil (‰). For carbon isotopes, the ¹³C/¹²C is expressed as δ¹³C_{VPDB}=(R_{SPL}−R_{VPDB})/(R_{VPDB})×1000‰, where R_{SPL} is the ¹³C/¹²C of the sample and R_{VPDB} is the ¹³C/¹²C of the international standard Vienna PeeDee Belemnite. In this work, the first sample injection in a replicate set was used as the reference for the ¹³C/¹²C calculation in order to demonstrate reproducibility.

### Example 8

### Microfabrication

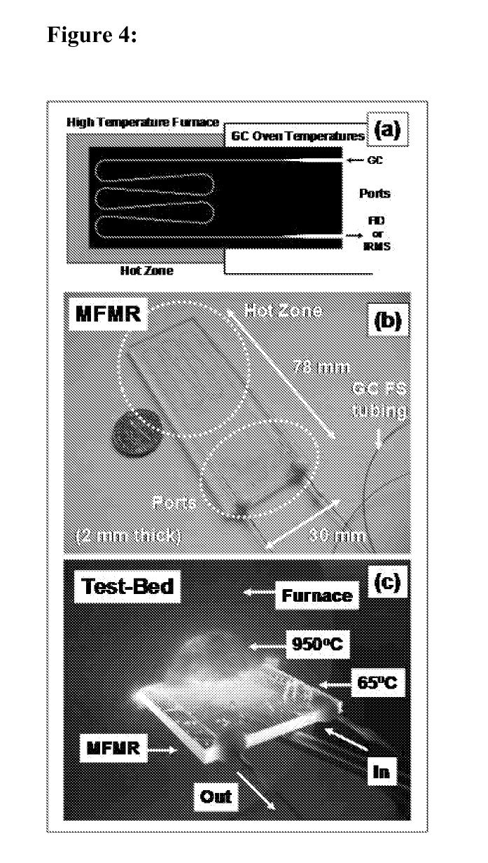

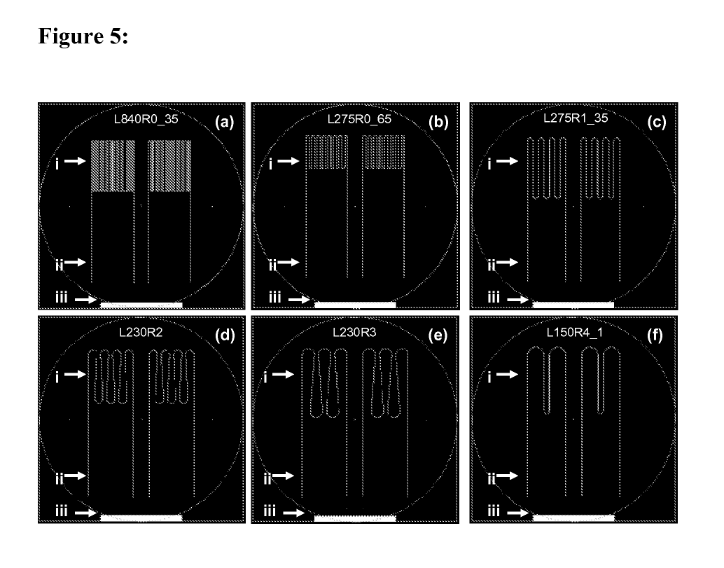

The general MFMR design (FIG. 4A) includes tapered source input and reactor output ports, in addition to a variable hot zone passage region. A photo of a completed MFMR with oxidized metal reactant is shown in FIG. 4B and the test-bed used to characterize the device is shown in FIG. 4C. Reactors were created containing hot zone passage lengths ranging from 150-840 mm, passage loop bend radii of 0.35-4.1 mm, and passage diameters varying from 56 to 209 μm. Reference to a specific reactor configuration is compactly made by the code LwwRxxD_{c}yyD_{w}zz, where ww is the Length (L) of the passage in the hot zone in mm, xx is the Bend Radius (R) in mm, yy is the hot zone Passage Diameter (D_{c}) in μm before the addition of metal reactant, and zz is the metal reactant Wire Diameter (D_{w}) in μm before oxidation. Photomasks were generated for the microreactor patterns with varying hot zone path lengths and passage bend radii (FIGS. 5A-F), where white regions are transparent, and made symmetric so that mirror image pairs can be matched later in the process. The hot zone passage region (FIG. 5, i's) is extended by the input and output ends of the reactor pattern (FIG. 5, ii's), which become the ports. Both ports lead to the edge of the substrate perpendicular to a wafer flat alignment bar (FIG. 5, iii's) used in the two step wet etch process described below. The width of the passages in the pattern are made significantly narrower (10 μm) than the ultimately etched passage width, ranging from 56-209 μm in this work.

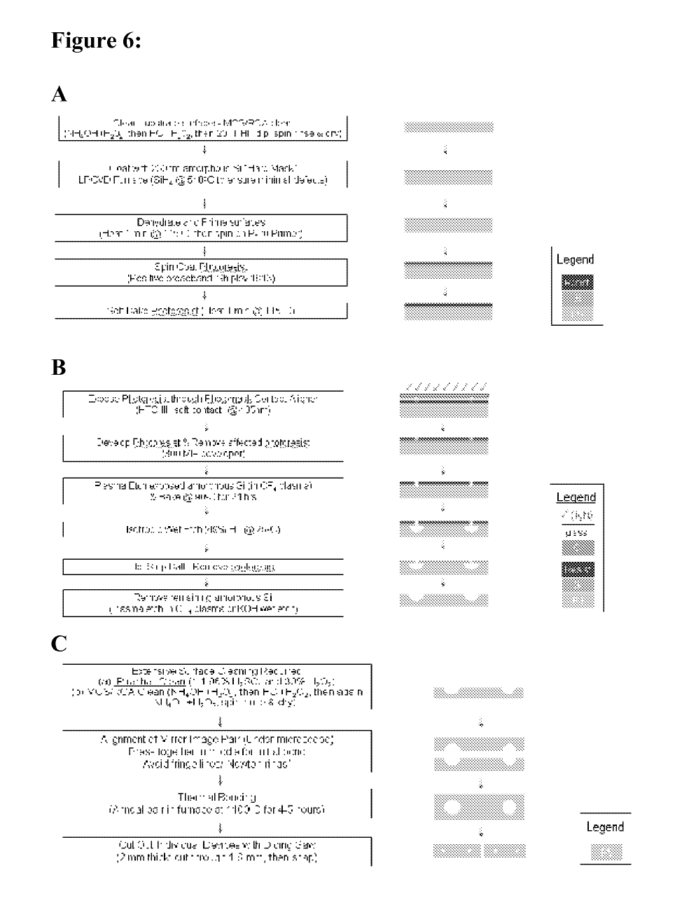

High purity fused silica substrates, 100 mm diameter with 1 mm thickness and a wafer flat, were prepared for photolithography (FIG. 6A). After thorough cleaning, one working side was coated with a 250 nm of Si as a protective layer mask, which was a coating that is resistant to the HF etchant. The deposition temperature and doping of Si was optimized through investigation of three different low pressure chemical vapor deposition (LPCVD) recipes (SR1, SR2, and SR3). An undoped Si layer formed at higher temperatures (SR1 @ 560° C.) formed a layer with excessive defects and pinholes, which appeared to be due to the initiation of crystalline Si formation, and resulted in a poor quality hard mask. A lower LPCVD temperature (SR2 @ 540° C.) resulted in a sufficiently amorphous layer of undoped Si with little to no defects, but was difficult to remove later in the process thereby promoting excessive surface roughness. An n-doped amorphous Si layer (SR3 @ 540° C.) was ultimately used due to its film quality, resistance to HF, and quick removal using KOH later in the process ensuring clean smooth surfaces for much improved wafer bonding compared to the use of undoped Si. The etch rate of n-doped Si in KOH was approximately ten times greater than that of undoped Si. After the Si layer was deposited, a broadband positive photoresist was spin coated on top of the hard mask.

In the structure fabrication process, FIG. 6B, the wafer was aligned under the photomask according to its wafer flat and alignment bar before exposure. The affected photoresist was removed using a developer, defining the passage pattern. These exposed regions in the hard mask were then CF₄ plasma etched, thereby uncovering the high purity fused silica surface. A two step isotropic wet etching process was used to create the semi-circular cross section micro-passages. Each pair of wafers, that were ultimately bonded, was etched in the same bath for optimal uniformity. First, the pair of wafers was fully immersed in 49% HF etchant for a period of time chosen to yield the desired “hot zone” passage dimensions. Second, the pair of wafers was stood on end facing one another on their wafer flat in the etchant, for an additional time period, so that only a few mm of the passage ends were immersed and achieved a wider etch diameter than the rest of the pattern. This created a taper from the hot zone passages to the input and output port passages. The HF bath was circulated with a stir bar to ensure uniformity of the etching process over long periods of time. In addition, the bath was physically rotated occasionally to ensure even exposure of non-immersed passages to HF vapors in the fume hood. For example, the reproducibility of the final enclosed hot zone passage dimensions when creating approximately 200 μm diameter passages was 202±4 μm (standard deviation for n=16 MFMR).

After HF etching, the remaining hard mask was removed by KOH wet etching yielding a smooth, flat substrate surface appropriate for bonding. The surface roughness was measured to be <8 angstroms rms. In the device packaging process (FIG. 6C), the two substrates were aligned under a microscope and pressed together to form the circular passages from the semi-circular cross-sections. Visible fringe lines (i.e. Newton rings) were evidence of gaps between the two wafers. It was imperative that no lines or rings were apparent anywhere near the etched features upon the bonding before the annealing process; otherwise, dead volumes and gas leaks between passages and/or outside of the final device always occurred. The fused silica surfaces adhere by hydrogen bonding attractive forces mediated largely by adsorbed water, maintaining alignment of the two halves. No adhesives are used. The pair was then annealed at high temperature, 1100° C., for a few hours yielding a permanent gas tight bond due to the creation of Si—O—Si bonds as water is driven away from the interface. The reactor(s) were then diced out of the bonded pair, where capillary port openings were created by cutting across the widened passage ends.

MFMR patterns were varied and tested with hot zone loop bend radii equal to and greater than 3 mm (with patterns L230R3 and L150R4_{—}1). These patterns permit insertion of 75 μm diameter metal reactant wire into passages of the completed device, as is normal for preparation of IRMS combustion reactors. Designs with much tighter loop bend radii can be created; however, deposition of metal reactant prior to bonding may be required. Evaporation, electroplating, and chemical vapor deposition processes are candidate approaches for incorporation into the microfabrication procedure. Fused silica capillary tubing (used for GC) was secured gas tight in each port using Pyro-Putty 950 (maximum operating temperature=510° C.) and TorrSeal (maximum operating temperature=120° C.), and, in one case, only polyimide resin (maximum operating temperature=350° C.) was evaluated for gas leaks and contained no reactant.

### Example 9

### Physical Robustness

MFMR enclosures were successfully constructed consisting of passages with diameters varying from 56 μm to 209 μm, which are narrower than previously developed low dead volume fused silica capillary tubing reactors used in IRMS (250-530 μm). A test bench was set up for heat testing of a MFMR at an operating temperature of 950° C. (FIG. 4C). A high temperature furnace was resistively heated to 950° C., as measured by a thermocouple, with the serpentine end of a MFMR (L275R0_{—}65D_{c}85 with no metal reactant) inserted into the hot zone. The inlet capillary was connected to flowing He and the outlet capillary was periodically connected to an IRMS. The MFMR with ports sealed with Pyro-Putty and TorrSeal, was held at 65° C. at the port ends and 950° C. at the hot zone region representing an 885° C. temperature gradient. Tests using Ar gas showed no evidence of leaks over 12 weeks, when the experiment was stopped. Moreover, during other experiments, various MFMR enclosures remained leak free through repeated temperature cycling between room and operating temperature; conventional fragile fused silica capillary reactors frequently crack or shatter due to thermal shock when cycling the reactor between 950° C. and room temperature for maintenance or as a result of power interruptions. A preliminary experiment with MFMR ports sealed with polyimide resin resulted in a device similarly resilient to changes in temperature. These observations demonstrate the great physical robustness of the MFMR design.

### Example 10

### Optimization of Peak shapes

At high temperatures, gas viscosity increases, leading to flow restriction and decreased flow rate in capillaries. Therefore, the relationship of MFMR hot zone passage diameter at 950° C. furnace temperature, and He carrier gas head pressure (flow) was explored empirically by fabricating a series of MFMR. MFMR enclosures (pattern L275R0_{—}65, as shown in FIG. 5B, with no metal reactant) of varying hot zone passage diameters were constructed.

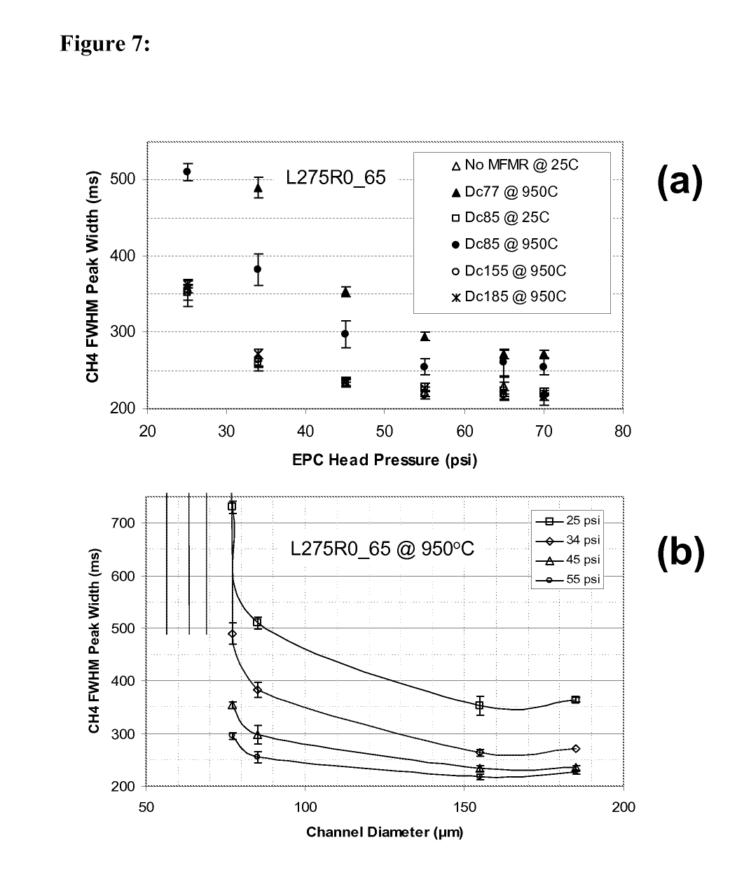

An Agilent 6890 GC-FID system with electronic pressure control (EPC) was fitted with 1.7 m total length of 100 μm i.d. capillary to couple the MFMR with the GC inlet and FID. The dependence of CH₄ FWHM peak widths on a wide range of head pressures was then explored. Flow rates of <1 ml/min to 6 ml/min were investigated depending on MFMR passage dimensions. FIG. 7A shows that as EPC head pressure increases, peak widths decrease. FWHM peak widths of 219±7 ms for 1.7 nmol CH₄ are achievable for MFMR's with pattern L275R0_{—}65 and passage diameters of 155 μm and 185 μm, using head pressures greater than or equal to 55 psi. This is equivalent to the FWHM peak widths resulting from no MFMR in-line, 224±8 ms, as shown in Table 1.

TABLE 1

| | CO₂ | CH₄ |
|---|---|---|
| | NO MFMR | WITH MFMR |
| FAST GC-FID | 224 ± 8 ms ^{a} | 219 ± 8 ms ^{b} |
| Peak Width (FWHM) | | |
| FAST GCC-IRMS | 253 ± 6 ms ^{c} | 250 ± 7 ms ^{c} |
| Peak Width (FWHM) | | |
| FAST GCC-IRMS | ±0.27 ms ‰ ^{c} | ±0.28 ms ‰ ^{c} |
| Carbon Isotope Ration Reproducibility | | |

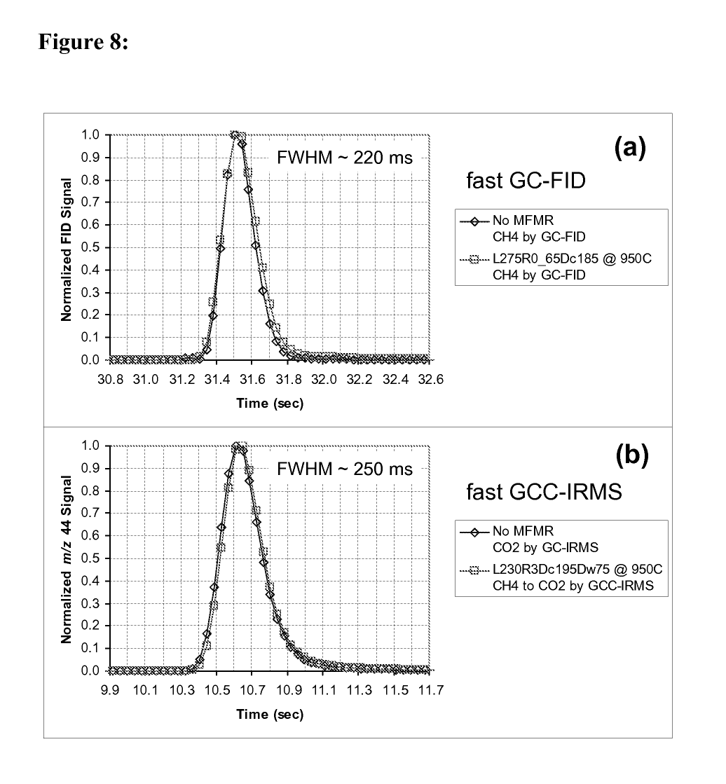

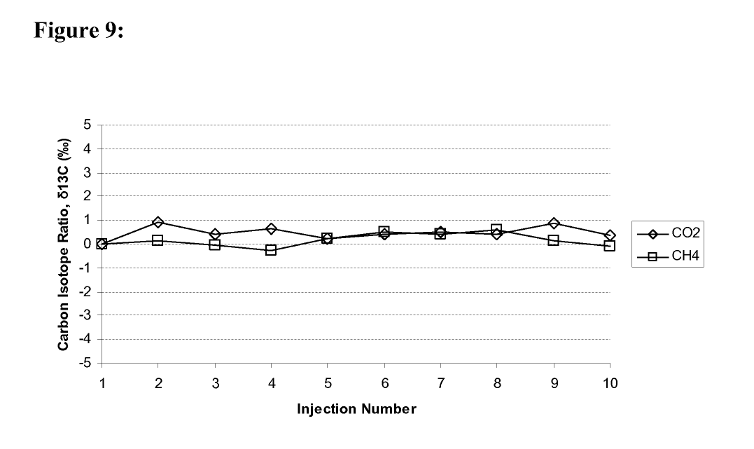

Peak widths and ¹³C/¹²C of CO₂ and CH₄ as measured by fast GC-FID and fast GCC-IRMS with and without an optimized MFMR in-line. MRMR used for fast GC-FID was L275R0_65D_{c}155 & L275R0_65D_{c}185 without reactant, and MFMR used for fast GCC-IRMS was L230R3D_{c}195D_{w}75 with oxidized metal wire. These are the summarized data for the results presented in FIG. 7, FIG. 8, and FIG. 9, where 1.7 nmol of each gas was analysed using fast GC-FID, and 2 nmol of each gas was analyzed using fast GCC-IRMS.
^{a} n = 12
^{b} n = 24,
^{c} n = 10.

For MFMR of pattern L275R0_{—}65 at 950° C. with hot zone passage diameters of 56 μm, 77 μm, and 85 μm, peak widths of <250 ms were not attainable, even at the highest EPC head pressure (70 psi). Using these measurements, FIG. 7B demonstrates that fast GC-FID FWHM peak widths of less than or equal to 225 ms can be achieved with a MFMR of pattern L275R0_{—}65 at 950° C. comprised of passage diameters approximately between 130 μm and 185 μm with head pressures greater than or equal to 55 psi. FIG. 8A shows that the CH₄ peak shape is the same through 1.7 m of 100 μm i.d. capillary at 25° C. as through the same capillary length including the MFMR with 185 μm diameter passages at 950° C. using FID detection. As a result, MFMR passage dimensions were successfully optimized to have a negligible effect on gas plug peak shapes at high temperatures.

### Example 11

### Combustion

A 55% Cu:45% Ni wire alloy (Constantan, Alfa Aesar, Ward Hill Mass.) compatible with 950° C. combustion for ¹³C/¹²C analysis by IRMS was investigated. The pre-oxidized wire diameter of 75 μm was chosen so that the effective passage diameter, after insertion into the hot zone of MFMR's with empty hot zone passage diameters of ˜200 μm, was ˜185 μm. After 100% oxidation, the wire volume should expand by almost a factor of two (˜1.7), bringing the effective diameter to ˜173 μm, targeting the middle of the optimized range (155-185 μm) for narrow peak shapes. However, the extent of oxidation and amount of expansion were not quantified in this work. MFMR's with loop diameters equal to or greater than 6 mm allowed reactant wire insertion; patterns L230R3 (FIG. 5E) and L150R4_{—}1 (FIG. 5F) were used in this work. The ports were then sealed to GC fused silica capillary tubing and the MFMR was interfaced to a fast-GCC-IRMS system. In order to prepare the MFMR for use as a combustion reactor, the hot zone region was held at 600° C. using a high temperature furnace while oxygen was flowed through the MFMR for at least 24 hrs generating CuO and NiO. The oxidized 75 μm wire facilitated normal flows with narrow peak widths.

The peak widths and ¹³C/¹²C of CO₂ and CH₄ gas plugs were evaluated with and without an MFMR in line. An MFMR with pattern L230R3 (FIG. 5E) was used and it comprised a hot zone passage diameter of 195 μm containing a 75 μm diameter oxidized Constantan wire, resulting in an effective diameter of <185 μm (L230R3D_{c}195D_{w}75). The analysis of 2 nmol of CO₂ without an MFMR was conducted to establish the baseline capability of the fast GCC-IRMS system. The analysis of 2 nmol of CH₄ was conducted with the MFMR described above, held at 950° C. The results in Table 1 and FIG. 8B show that peak shapes and widths, which are ˜250 ms FWHM, are not affected by the MFMR. This shows a little more broadening for the GCC-IRMS system compared to the GC-FID system (FIG. 8A); however, it is not unexpected due to the IRMS ion source inlet and the extra GC fused silica capillary length required for the GCC-IRMS configuration. Also, reproducibility of ¹³C/¹²C measurements of CH₄ when using the MFMR was measured to be SD(δ¹³C)=±0.28‰, which is the same as for plugs of CO₂, which was SD(δ¹³C)=±0.27‰. FIG. 9 shows a plot of 10 consecutive injections of CO₂ and CH₄ and demonstrates no observed trend for ¹³C/¹²C values. This replicate analysis of CO₂ and CH₄ yielded similar m/z 44 peak areas, (1.1±0.1 V s), suggesting completeness of CH₄ oxidation since equivalent volumes of each gas contain equivalent moles of carbon.

The system was evaluated with samples of approximately 2 nmol C, near the usual limit for precise and accurate IRMS analysis. In a previous work, samples of approximately 10 pmol C were considered, for which the counting statistical limit is SD(δ¹³C)˜0.3‰. It was found that precision scales inversely to the peak width. For instance, 250 ms FWHM peak widths from fast GCC-IRMS achieve 10 times better precision (0.4‰) than a 10-fold wider peak expected in normal GCC-IRMS (Sacks et al., “Fast Gas Chromatography Combustion Isotope Ratio Mass Spectrometry,” Analytical Chemistry 79:6348-58 (2007), which is hereby incorporated by reference in its entirety). Precision is likely to be limited by the ability to reproducibly define baseline, and shows that lower analyte concentrations can be employed while maintaining high precision because of the sharper peaks obtained with fast GC. Experiments addressing peak shape and combustion efficiency using the MFMR with different reactant types and quantities and passage dimensions for various compounds of interest, such as polar steroids, are required to characterize this property with MFMR. In these initial studies that focused on microfabrication, TorrSeal port seals were used and function only up to 120° C. Future experiments will be facilitated by the development of the MFMRs with, for instance, polyimide port seals that are resistant to GC oven temperatures up to 350° C., thus enabling compound separation analyses of lower vapor pressure and polar compounds, such as those with formula weights of >100 g/mol. Importantly, the MFMR can support larger passage dimensions for use as a more robust reactor as part of normal GCC-IRMS systems, improving their reliability as well.

Microfabricated microreactors (MFMR) were designed and developed using established and novel microfabrication techniques. The process was adopted for the steps, to create circular passages, that resemble those of recent microfabrication of passages in various substrates (Bu et al., “A New Masking Technology for Deep Glass Etching and Its Microfluidic Application,” Sens. Actuator A-Phys. 115:476-82 (2004); Grosse et al., “Deep Wet Etching of Fused Silica Glass for Hollow Capillary Optical Leaky Waveguides in Microfluidic Devices,” Journal of Micromechanics and Microengineering 11:257-62 (2001); Iliescu et al., “On the Wet Etching of Pyrex Glass,” Sens. Actuator A-Phys. 143:154-61 (2008); Iliescu et al., “Characterization of Masking Layers for Deep Wet Etching of Glass in an Improved HF/HCl Solution,” Surf. Coat. Technol. 198:314-8 (2005); Iliescu et al., “Strategies in Deep Wet Etching of Pyrex glass,” Sens. Actuator A-Phys. 133:395-400 (2007); and U.S. Pat. No. 5,575,929 to Yu et al., which are hereby incorporated by reference in their entirety). However, the processes of the present invention were performed in high purity fused silica (SiO₂), which is required for high temperature applications but also is a difficult material to micro-machine at the required dimensions of 100's of μm and to maintain flatness and smoothness over many cm. Pure SiO₂ has a much higher softening point and etches many times slower than impure SiO₂ requiring well chosen protective layer masks for long etch times. Wet etching of small dimension structures (<20 μm), is routinely done and simpler compared to deep (>50 μm) wet etching due to the need for balance between etch time and protective layer resistance. Considering this, one particularly novel aspect to the fabrication process of the present invention is the use of n-doped amorphous silicon (Si) which resisted HF etching well but could be removed quickly using KOH. It yielded a smooth substrate surface and routine success in creating permanently sealed devices after thermal bonding of wafers. Another original aspect of the process of the present invention is a “two step isotropic wet etch” process to create tapered connection ports for input and output capillaries, which are similar to the commercially available Press-Tight® connections. Integrity of the reactor at elevated temperatures was assessed through leak checking. Fast GC plugs of CO₂ gas and CH₄ were used to evaluate peak broadening, extent of combustion, and ¹³C/¹²C reproducibility using the MFMR as part of a GCC-IRMS interface. In addition, hot zone loop bend radii equal to and greater than 3 mm allowed insertion of metal reactant wire. When interfaced to GCC-IRMS, the MFMR enables state of the art ¹³C/¹²C reproducibility, the hallmark of high precision IRMS.

### Example 12

### Micro-Fabricated On-Line Microreactors Enabling Fast Gas Chromatography (GC) and Comprehensive 2D GC (GC×GC) Coupled to Isotope Ratio Mass Spectrometry (IRMS)

The feasibility of interfacing fast GC and GC×GC to combustion IRMS has been demonstrated. This coupling necessitates the preservation of very narrow peak widths required for fast GC separation and was made possible using a capillary-based combustion reactor design. However, robustness to facilitate reliable, high performance operation requires improvements of the system in three areas. First, post-column band broadening can be further minimized by reducing the i.d. of the reactor from the current value of 0.25 mm. Second, improvement of the physical stability of the reactor at high temperatures is required. Third, the improvement of the combustion capacity of the reactor is desired for extended periods of operation. These problems can be addressed by micro-fabrication.

Equipment in the Cornell NanoScale Science and Technology Facility, a national laboratory for nanofabrication, was used for micro-fabrication. A layer of amorphous Si was deposited onto 4 inch fused silica (FS) wafers. Photoresist was spin coated onto the surface of the wafers, exposed through a photomask using contact alignment, and developed. A CF₄ plasma was used to etch off the exposed Si, and the photoresist was subsequently removed. The wafers were then isotropically etched over time in an HF bath. Copper metal was then deposited in the passages. Two wafers with mirror images of the pattern were anodically bonded. An HP6890A gas chromatograph was interfaced to a Finnigan MAT 252 IRMS with the microreactor.

Micro-fabrication allowed the creation of long, narrow-bore reactor passages in a relatively small surface area by using a serpentine design pattern. A Si based hard mask was optimized to create passages of half semicircles on individual wafers by wet etching in an HF bath. Two wafers with mirror images of the pattern were bonded to enclose the passages. This enabled the micro-machining of approximately 85 micron diameter spherical passages, with input and output regions of larger dimensions to allow attachment to fused silica capillary. Rather than packing with metal wire, as is done with larger dimension reactor tubes, a thin film of copper was deposited on the inside of the etched passages via metal evaporation. Integrity of the reactor at elevated temperatures was accessed though leak checking.

In addition, the peak shapes of fast GC plugs of CO₂ gas and methane were evaluated through the microreactor when used in a GC-combustion IRMS interface. Micro-fabrication was used to develop superior and robust combustion microreactors enabling the retention of fast GC peak shapes for IRMS.

### Example 13

### Compound-Specific Isotope Analysis of Carbon Using Micro-Fabricated Micro-Reactor and Cavity Ring-Down Spectrometry

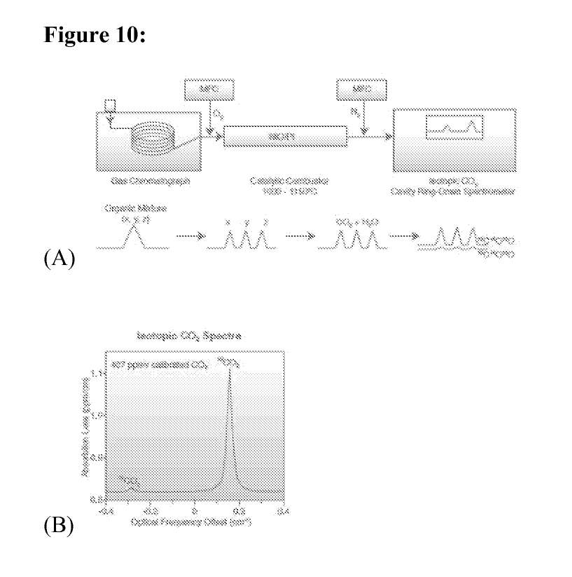

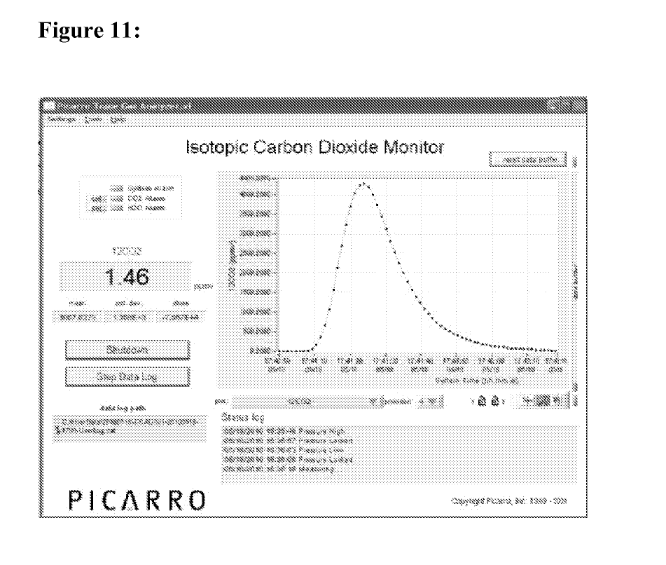

This example presents an alternative approach for making high-precision CSIA measurements of the ¹³C/¹²C isotope ratio of organic compounds, which is less expensive, does not require highly trained personnel, and can easily be made portable (FIGS. 10 and 11). The technique relies on the chromatographic separation of a mixture into individual organic compounds, the combustion of each organic compound, using the micro-fabricated microreactor (MFMR) of the present invention, into carbon dioxide, water, and other oxidation products, and the precise measurement of the ¹³C/¹²C isotope ratio in the carbon dioxide gas using the ultra sensitive absorption method of cavity ring-down spectroscopy. More specifically, the two small molecules yielded by the combustion process of hydrocarbons allow a single instrumentation system to analyze a mixture of the hydrocarbon compounds with varying carbon chain length as the two common denominators, CO₂ and H₂O, of the more complex parent molecule of interest. It also permits the measurement of the resulting ¹³C/¹²C ratio from the simple and well established carbon dioxide infrared spectrum with CRDS. Short chain hydrocarbons are used as test compounds owing to their mud logging diagnostic significance in exploratory and routine oil drilling and the suitability of the present instrumental setup for such a field measurement application.

A Hewlett Packard 5890 Series II gas chromatograph (Agilent, USA) is connected to a CRDS instrument through a cylindrical oven chamber (8″L×7.5″ dia) housing a novel microfabricated microreactor (MFMR) of the present invention. The oven heated zone is 4″ sandwiched by two 2″ vestibules, where one vestibule has an insertion slot machined in it to admit the MFMR and a hole drilled to accommodate the thermocouple. Individual injections of 60 μl methane, 30 μl ethane, and 20 μl propane (all 99.5% or higher grade purity) are introduced in splitless mode on a GC capillary column (Agilent J&W, HP-PLOT Q, 30 m×0.53 mm i.d., 40 μm film thickness). The helium carrier gas linear velocity (Ultra-High Purity 99.999%) through the column is 30 cm/s. For individual samples of methane, ethane, and propane, the temperature is held constant at 60° C. The injector temperature was set to 150° C. for all the analyses. The output of the column is connected with a stainless steel Tee-connector to an MFMR held in a resistively heated furnace with a feedback temperature control operating between 1000° C. and 1070° C. The MFMR has an etched diameter channel of 505 μm with 0.53 mm i.d. fused silica transfer capillary attached to its inlet and outlet holes. The hot zone path length is ca. 160 mm long. One platinum (100 μm dia), one nickel (100 μm dia), and one copper wire (130 μm dia) are braided and inserted into the bore of the MFMR and the nickel/Cu wires were initially oxidized at a 600° C. temperature with oxygen passing over the wire, before the temperature was raised to its respective operating temperature (1000° C.-1070° C.). The MFMR is positioned so that the end of the micro-reactor is at least 1 cm from the furnace vestibule (equivalent to 3.54 cm from the furnace hot zone) to reduce heat radiation onto the sealed capillaries of the inlet and outlet on the micro-reactor. A flow of one cubic centimeter per minute of oxygen (99.6% purity) is passed though the MFMR, via the orthogonal port of the Tee-connector, during analysis runs to ensure the availability of excess oxygen supply for the complete oxidation of the sample and to regenerate the catalyst. The combustion products from the oxidation reactor are fed directly into the CRDS fast analyzer. A flow of 25 cm³/min of nitrogen (99.95% purity) is concurrently fed into the instrument to help control the flow rate of the sample passing through the CRDS cavity. The chromatograms from the instrument are analyzed using a trapezoidal integration in Microsoft Excel.

TABLE 2

| Sample | GC-C-CRDS | GC-C-IRMS |
|---|---|---|
| Methane | −45.88 ± 0.58‰ | −44.07 ± 0.46‰ |
| Ethane | −36.47 ± 0.52‰ | −37.68 ± 0.41‰ |
| Propane | −38.98 ± 0.76‰ | −39.57 ± 0.20‰ |

### Carbon Isotope Ratios of Methane, Ethane, and Propane Using GC-C-CRDS and GC-C—IRMS.

The GC-C-CRDS system using the novel micro-fabricated micro-reactor proved to be linear over a three-fold injection volume dynamic range with an average precision of 0.58‰ for methane, 0.52‰ for ethane, and 0.76‰ propane, respectively. The calibrated accuracy for methane, ethane, and propane is within 2‰ of the values determined using isotope ratio mass spectrometry (IRMS), which is the current method of choice for compound-specific isotope analysis. With anticipated improvements, the low cost, portability, and easy-of-use of CRDS-based instrumental setup is poised to evolve into a credible challenge to the high-cost and complex IRMS-based technique.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed:

1. A microreactor comprising:
a substrate having an outer periphery and comprising two monolithic sections, each of said monolithic sections comprising two opposed main surfaces and one or more edges extending between the main opposed surfaces, wherein one of the main surfaces from each of the monolithic sections are joined together at a substantially planar junction;
at least one microcapillary flow passage defined by surfaces within said substrate and having first and second ends;
one or more inlets connecting the outer periphery of said substrate with the first end of said microcapillary flow passage; and
one or more outlets connecting the outer periphery of said substrate with the second end of said microcapillary flow passage, wherein said inlet and/or outlet narrowingly tapers from the outer periphery of said substrate into said microcapillary flow passage.

2. The microreactor according to claim 1 further comprising:
a capillary tube coupled to said one or more inlet and
a capillary tube coupled to said one or more outlet.

3. The microreactor according to claim 1, wherein said microcapillary flow passage comprises either two or more parallel flow passages, two or more flow passages which merge together into one flow passage, or a flow passage that splits into two or more flow passages.

4. The microreactor according to claim 1, wherein said microcapillary flow passage has either a serpentine pattern, a concentric pattern, or any desired pattern designed for a specific purpose.

5. The microreactor according to claim 1, wherein said microcapillary flow passage is substantially coplanar with the planar junction.

6. The microreactor according to claim 1, wherein said one or more inlet and said one or more outlet extend through the edge of the joined monolithic sections of said substrate and are substantially coplanar with the planar junction.

7. The microreactor according to claim 1 further comprising:
a metallic reagent and/or catalyst within said microcapillary flow passage.

8. The microreactor according to claim 7, wherein said metallic reagent and/or catalyst is coated on the surfaces of said substrate defining said microcapillary flow passage.

9. The microreactor according to claim 1, wherein said substrate is made of high purity fused silica.

10. A method of heating a material, said method comprising:
providing said microreactor according to claim 1;
heating said microreactor;
passing the material through said inlet, said microcapillary flow passage, and said outlet of said heated microreactor to heat the material; and
recovering the heated material after it is discharged from said outlet of said heated microreactor.

11. The method according to claim 10, wherein said method causes the material to undergo a chemical or biological reaction.

12. The method according to claim 10 further comprising:
subjecting the recovered heated material to chemical analysis.

13. The method according to claim 12, wherein the chemical analysis is carried out with an instrument selected from the group consisting of a gas chromatograph, a mass spectrometer, an isotope ratio monitoring gas chromatograph mass spectrometer (irm-GC/MS), a molecular mass spectrometer, and a spectrometer or spectroscopy instrument for chemical or isotopic analysis.

14. A microreactor comprising:
a substrate having an outer periphery and comprising two monolithic, high purity fused silica sections, each of said monolithic sections comprising two opposed main surfaces and one or more edges extending between the main opposed surfaces, wherein one of the main surfaces from each of the monolithic sections are joined together at a substantially planar junction;
at least one microcapillary flow passage defined by surfaces within said substrate and having first and second ends;
one or more inlets connecting the outer periphery of said substrate with the first end of said microcapillary flow passage; and
one or more outlets connecting the outer periphery of said substrate with the second end of said microcapillary flow passage.

15. The microreactor according to claim 14 further comprising:
a capillary tube coupled to said one or more inlet and
a capillary tube coupled to said one or more outlet.

16. The microreactor according to claim 14 wherein said microcapillary flow passage comprises either two or more parallel flow passages, two or more flow passages which merge together into one flow passage, or a flow passage that splits into two or more flow passages.

17. The microreactor according to claim 14, wherein said microcapillary flow passage has either a serpentine pattern, a concentric pattern, or any desired pattern designed for a specific purpose.

18. The microreactor according to claim 14, wherein said microcapillary flow passage is substantially coplanar with the planar junction.

19. The microreactor according to claim 14, wherein said one or more inlet and said one or more outlet extend through the edges of the joined monolithic sections of said substrate and are substantially coplanar with the planar junction.

20. The microreactor according to claim 14 further comprising:
a metallic reagent and/or catalyst within said microcapillary flow passage.

21. The microreactor according to claim 20, wherein said metallic reagent and/or catalyst is coated on the surfaces of said substrate defining said microcapillary flow passage.

22. A method of heating a material, said method comprising:
providing said microreactor according to claim 14;
heating said microreactor;
passing the material through said inlet, said microcapillary flow passage, and said outlet of said heated microreactor to heat the material; and
recovering the heated material after it is discharged from said outlet of said heated microreactor.

23. The method according to claim 22, wherein said method causes the material to undergo a chemical or biological reaction.

24. The method according to claim 22 further comprising:
subjecting the recovered heated material to chemical analysis.

25. The method according to claim 24, wherein the chemical analysis is carried out with an instrument selected from the group consisting of a gas chromatograph, a mass spectrometer, an isotope ratio monitoring gas chromatograph mass spectrometer (irm-GC/MS), a molecular mass spectrometer, and a spectrometer or spectroscopy instrument for chemical or isotopic analysis.

26. A microreactor comprising:
a substrate having an outer periphery and comprising two monolithic sections, each of said monolithic sections comprising two opposed main surfaces and one or more edges extending between the main opposed surfaces, wherein one of the main surfaces from each of the monolithic sections are joined together at a substantially planar junction;
at least one microcapillary flow passage defined by surfaces within said substrate and having first and second ends;
a metallic reagent and/or catalyst coated on the surfaces of said substrate defining said at least one microcapillary flow passage;
one or more inlets connecting the outer periphery of said substrate with the first end of said microcapillary flow passage; and
one or more outlets connecting the outer periphery of said substrate with the second end of said microcapillary flow passage.

27. The microreactor according to claim 26 further comprising:
a capillary tube coupled to said one or more inlet and
a capillary tube coupled to said one or more outlet.

28. The microreactor according to claim 26, wherein said microcapillary flow passage comprises either two or more parallel flow passages, two or more flow passages which merge together into one flow passage, or a flow passage that splits into two or more flow passages.

29. The microreactor according to claim 26, wherein said microcapillary flow passage has either a serpentine pattern, a concentric pattern, or any desired pattern designed for a specific purpose.

30. The microreactor according to claim 26, wherein said microcapillary flow passage is substantially coplanar with the planar junction.

31. The microreactor according to claim 26, wherein said one or more inlet and said one or more outlet extend through the edge of the joined monolithic sections of said substrate and are substantially coplanar with the planar junction.

32. A method of heating a material, said method comprising:
providing said microreactor according to claim 26;
heating said microreactor;
passing the material through said inlet, said microcapillary flow passage, and said outlet of said heated microreactor to heat the material; and
recovering the heated material after it is discharged from said outlet of said heated microreactor.

33. The method according to claim 32, wherein said method causes the material to undergo a chemical or biological reaction.

34. The method according to claim 32 further comprising:
subjecting the recovered heated material to chemical analysis.

35. The method according to claim 34, wherein the chemical analysis is carried out with an instrument selected from the group consisting of a gas chromatograph, a mass spectrometer, an isotope ratio monitoring gas chromatograph mass spectrometer (irm-GC/MS), a molecular mass spectrometer, and a spectrometer or spectroscopy instrument for chemical or isotopic analysis.

36. A method of fabricating a microreactor, said method comprising:
providing a substrate having an outer periphery and comprising a pair of monolithic sections, each of the monolithic sections comprising two opposed main surfaces and one or more edge extending between the opposed main surfaces;
etching a microcapillary flow passage in one of the main surfaces of each of the pair of monolithic sections, wherein the microcapillary flow passage is defined by surfaces in the substrate and has first and second ends;
etching one or more inlet in the etched main surface of each of the pair of monolithic sections which extends through the edge and is connected to the first end of the microcapillary flow passage;
etching one or more outlet in the etched main surface of each of the pair of monolithic sections which extends through the edge and is connected to the second end of the microcapillary flow passage; and
joining each of the etched main surfaces of the monolithic sections together with the one or more inlet, the microcapillary flow passage, and the one or more outlet in alignment, wherein the one or more inlet and/or the one or more outlet narrowingly tapers from the outer periphery of said substrate to the microcapillary flow passage.

37. The method according to claim 36, wherein said etching the microcapillary flow passage is carried out by immersing the main surface of each of the pair of monolithic sections in an etching solution, and said etching the one or more inlet and one or more outlet is carried out by immersing only the one or more edge of the monolithic sections of said substrate through which the one or more inlet and the one or more outlet extends in the etching solution, thereby exposing said inlet and outlet to further etching.

38. The method according to claim 36, wherein the substrate is high purity fused silica.

39. The method according to claim 36 further comprising:
providing a metallic reagent and/or catalyst in the microcapillary flow passage prior to said joining.

40. The method according to claim 39, wherein said providing comprises:
coating the metallic reagent and/or catalyst on the surfaces of the substrate defining the microcapillary flow passage.

41. A method of fabricating a microreactor, said method comprising:
providing a high purity fused silica substrate having an outer periphery and comprising a pair of monolithic sections, each of the monolithic sections comprising two opposed main surfaces and one or more edge extending between the opposed main surfaces;
etching a microcapillary flow passage in one of the main surfaces of each of the pair of monolithic sections, wherein the microcapillary flow passage is defined by surfaces in the substrate and has first and second ends;
etching one or more inlet in the etched main surface of each of the pair of monolithic sections which extends through the edge and is connected to the first end of the microcapillary flow passage;
etching one or more outlet in the etched main surface of each of the pair of monolithic sections which extends through the edge and is connected to the second end of the microcapillary flow passage; and
joining each of the etched main surfaces of the monolithic sections together with the one or more inlet, the microcapillary flow passage, and the one or more outlet in alignment.

42. The method according to claim 41 further comprising:
providing a metallic reagent and/or catalyst in the microcapillary flow passage prior to said joining.

43. The method according to claim 42, wherein said providing comprises:
coating the metallic reagent and/or catalyst on the surfaces of the substrate defining the microcapillary flow passage.

44. A method of fabricating a microreactor, said method comprising:
providing a substrate having an outer periphery and comprising a pair of monolithic sections, each of the monolithic sections comprising two opposed main surfaces and one or more edge extending between the opposed main surfaces;
etching a microcapillary flow passage in one of the main surfaces of each of the pair of monolithic sections, wherein the microcapillary flow passage is defined by surfaces in the substrate and has first and second ends;
etching one or more inlet in the etched main surface of each of the pair of monolithic sections which extends through the edge and is connected to the first end of the microcapillary flow passage;
etching one or more outlet in the etched main surface of each of the pair of monolithic sections which extends through the edge and is connected to the second end of the microcapillary flow passage;
coating a metallic reagent and/or catalyst on the surfaces of the substrate defining the microcapillary flow passage; and
joining each of the etched, coated main surfaces of the monolithic sections together with the one or more inlet, the microcapillary flow passage, and the one or more outlet in alignment.
